(19) United States
(12) Patent Application Publication
(10) Pub. No.: US 2013/0268363 A1
(43) Pub. Date: Oct. 10, 2013

(54) TRANSMITTING DATA TO ELECTRONIC POSTING LOCATIONS

(71) Applicant: Inflection Point Retail, LLC, Windermere, FL (US)

(72) Inventors: Michael A. Liberty, Portland, ME (US); Brittany S. Abbass, Naples, FL (US)

(21) Appl. No.: 13/908,763

(22) Filed: Jun. 3, 2013

Related U.S. Application Data
(62) Division of application No. 12/846,436, filed on Jul. 29, 2010, now abandoned.
(60) Provisional application No. 61/230,508, filed on Jul. 31, 2009.

(51) Int. Cl. G06Q 30/02

(52) U.S. Cl. CPC G06Q 30/0257
USPC 705/14.55

(57) ABSTRACT

Data is compiled into notifications and sent to subscribers at electronic posting locations. The notifications are transmitted via instantaneous electronic means, such as SMS text message, picture message, e-mail, or micro-blogging, a price discount notification. Computer systems enabled to practice the present invention, comprising one or more databases and a communications system configured to transmit price discount notifications, are also described.

### CROSS-REFERENCE TO RELATED APPLICATIONS

This application is a divisional of U.S. patent application Ser. No. 12/846,436, filed on Jul. 29, 2010, which claims the benefit of U.S. Provisional Patent Application No. 61/230,508, filed on Jul. 31, 2009, both of which are incorporated herein by reference in their entireties.

### BACKGROUND

1. Background and Relevant Art

Grocery and retail stores lose significant revenue on wasted inventory due to the time sensitive nature of the goods and products being sold. For example, many meats can be refrigerated for between only one and five days before they spoil. If meat is on display at a grocery store for that period of time without being purchased, it must be discarded, thereby depriving the store of potential revenue from that item. In fact, the Food Marketing Institute estimated that annually, the U.S. grocery industry loses over $2 billion on “unsaleables,” that is, products that can no longer be sold in stores due to damage, expirations, etc.

This phenomenon is not unique to just meat. Most grocery items will perish or spoil a given amount of time after being made or packaged, including cereal, frozen foods, baked goods, soups, and most other items sold at a grocery store. The shelf life of a product can range from hours to days or months and even years sometimes. Often, the “sell by date” of a product is marked right on the packaging. Moreover, many other items sold in grocery stores or in retail stores lose significant value after being on display for a long period of time, including circuit components, clothing, pharmaceuticals, chemicals, cosmetics, organic products, and the like.

Because items in danger of perishing or becoming outdated cannot be sold for full price, grocery and retail stores are in need of a method for maximizing the revenue generated on the disposal of these items. Currently, many stores are required to manually discard many items as they spoil. Some stores might return outdated products to the manufacturer or donate them to charities. Many stores will offer items in danger of spoiling or perishing to the public at discounted prices. Unfortunately, because of a store's inability to advertise these items in a timely manner through traditional advertisement mechanisms, such as newspaper, radio, and television ads, many of these items still never sell, and thus grocery and retail stores lose significant revenue from these potential sales.

Consumers are also at a disadvantage because of their inability to learn of items in danger of perishing or spoiling being offered at discounted prices. Many consumers are willing to pay less for items knowing that they would be required to utilize the items quickly before they perish or spoil. However, common methods of advertising sale items to consumers, such as print, television, and the like, are unable to advertise spoiling or otherwise perishing items at a discounted rate in a timely manner before the items do spoil or otherwise perish. Thus, many consumers miss opportunities to save money at a grocery or retail store.

### BRIEF SUMMARY

The present invention extends to methods, systems, and computer program products for communicating price discounts. In some embodiments a price reduction for an item is communication to relevant entities. It is determined that generation of a price discount for an item is appropriate to mitigate revenue loss related to the item. The determination is based on inventory level data indicating that the amount of the item in inventory exceeds a predefined number and based on life cycle data indicating that the item is within a predefined time period of expiring.

A computer system generates a discount record for the item in response to the determination. The discount record is constructed from data contained in a product life cycle database, a discount database, and a contact database. The discount record contains a price discount for the item, a notification time, a number of units, and communication information. The price discount indicates how much the price of the item is discounted from a list price a notification time. The notification time indicates when relevant entities are to be notified of the price discount. The number of units indicates the number of units of the item being offered in accordance with the price discount. The communication information indicates how relevant entities interested in price discounts for the item are to be made aware of the price discount and the number of items being offered.

At the notification time, electronic network based communication is used to send notification information contained in the discount record to the relevant entities in accordance with the communication information. The notification information notifies the relevant entities of the number of units of the item being offered in accordance with the price discount.

The invention can be applied wherever an entity desires to make known that prices of a specific item or service are going to be discounted, including computer software and/or hardware, plane tickets, event tickets, hotel rates, and the like. The invention can be practiced by any entity that participates in commerce needing to advertise specific promotions or sales, including manufacturers, suppliers, distributors, and the like.

In some embodiments, consumers are electronically alerted to an imminent or impending price reduction on an item, such as, for example, a grocery or other retail item. For example, embodiments of the invention include notifying consumers that particular perishable items are being discounted because they are in danger of perishing or expiring soon. Electronic communication, such as, for example, text messages, picture messages, voice messages, e-mail, micro-blogging, etc., can be used to expedite consumer notifications.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates communicating price discounts.

FIG. 2 illustrates a flow chart of an example method for communicating price discounts, with optional feedback for optimizing subsequent revenue.

### DETAILED DESCRIPTION

The present invention extends to methods, systems, and computer program products for communicating price discounts. Embodiments of the invention extend to multi-channel communication for communicating price discounts. Price discounts can be communicated on a multi-channel basis including a combination of one or more of: voice interactive voice response (“IVR”), point of sale, mobile, telephonic, interactive, Internet, cable, and broadcast media.

In some embodiments a price reduction for an item is communication to relevant entities. It is determined that generation of a price discount for an item is appropriate to mitigate revenue loss related to the item. The determination is based on inventory level data indicating that the amount of the item in inventory exceeds a predefined number and based on life cycle data indicating that the item is within a predefined time period of expiring.

A computer system generates a discount record for the item in response to the determination. The discount record is constructed from data contained in a product life cycle database, a discount database, and a contact database. The discount record contains a price discount for the item, a notification time, a number of units, and communication information. The price discount indicates how much the price of the item is discounted from a list price at notification time. The notification time indicates when relevant entities are to be notified of the price discount. The number of units indicates the number of units of the item being offered in accordance with the price discount. The communication information indicates how relevant entities interested in price discounts for the item are to be made aware of the price discount and the number of items being offered.

At the notification time, electronic network based communication is used to send notification information contained in the discount record to the relevant entities in accordance with the communication information. The notification information notifies the relevant entities of the number of units of the item being offered in accordance with the price discount.

The invention can be applied wherever an entity desires to make known that prices of a specific item or service are going to be discounted, including computer software and/or hardware, plane tickets, event tickets, hotel rates, and the like. The invention can be practiced by any entity that participates in commerce needing to advertise specific promotions or sales, including manufacturers, suppliers, distributors, and the like.

In some embodiments, consumers are electronically alerted to an imminent or impending price reduction on an item, such as, for example, a grocery or other retail item. For example, embodiments of the invention include notifying consumers that particular perishable items are being discounted because they are in danger of perishing or expiring soon. Electronic communication, such as, for example, text messages, picture messages, voice messages, e-mail, micro-blogging, etc., can be used to expedite consumer notifications.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or database data (e.g., data structures). Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, DVD, or other optical disk storage, magnetic disk storage or other magnetic storage devices, or any other medium or computer storage device, which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices.

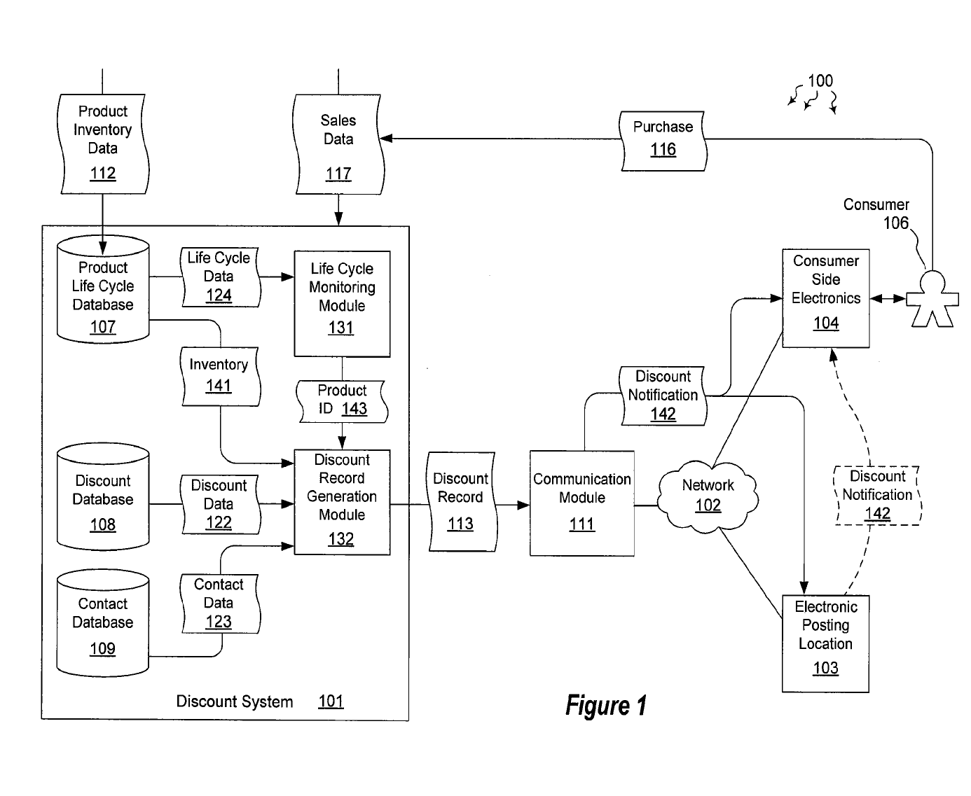

FIG. 1 illustrates an example computer architecture 100 that facilitates communicating price discounts. As depicted, computer architecture 100 includes discount system 101, communication module 111, network 102, electronic posting location 103, and consumer side electronics 104. Each of discount system 101, communication module 111, posting location 103, and consumer side electronics 104 is connected to is connected to one another over (or is part of) network 102, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

As depicted, discount system 101 includes product life cycle database 107, discount database 108, contact database 109, life cycle monitoring module 131, and discount record generation module 132.

Product life cycle database 107 contains life cycle data relating to the times and/or dates which products are set to perish or otherwise expire (e.g., “product life cycle data”). From time to time, product life cycle database 107 can receive product inventory data (e.g., product inventory data 112), which includes inventory levels, sell by dates, use by dates, and the like for one or more items products. Product inventory data can include expiration data, use by data, inventory levels, which can be updated in real time.

In some embodiments, radio-frequency ID (“RFID”) tags embedded within items provide inventory data to discounts system 101. Using RFID tags, sizing information, for items otherwise having the same Stock Keeping Unit (“SKU”), can be tracked. As such, when a particular size of (e.g., a clothing) item is selling at a different rate than other sizes, adjustments to pricing and/or inventory can be made.

Product life cycle data can correspond to any product or class of products in a grocery or retail store that has a limited shelf life, including, but not limited to clothing, perishable food items, pharmaceuticals, chemicals, electronics, ammunition, cosmetics, and the like. Thus, in one embodiment, product life cycle database 107 includes information relating to the expiration of each individual product on the shelves or on display in a retail location, including each product's current inventory level and sell by/use by date. Alternately or in combination, product life cycle database 107 can contain product life cycle data for a class or group of products perishing or otherwise expiring at essentially the same time.

Any number of mechanisms for tracking and recoding the product lifecycle or shelf life can be used. For example, radio frequency identification (“RFID”) devices, stock keeping units (“SKU”), Universal Product Code (“UPC”), and the like can be used to track and record product life cycles and shelf lives. Tracking mechanisms can use hardware and/or software to track inventory levels, including seasonal or perishable item management. For example, RFID mechanisms can be used to allow a user to manually generate a list of items set to expire within a given timeframe. Accordingly, embodiments of the invention can be used in combination with inventory management systems that monitor real time product inventory levels, expiration data, and the like.

Discount database 108 contains data related to the magnitude (e.g., an amount or percentage) and timing of price discounts (“price discount data”). The magnitude of a discount can be applied to a particular product or a group or class of products. The timing of a discount indicates how soon before, during, or after expiration of a product or class or group of products, the price of the product or class or group do products of products is to be discounted. Price discount data can be updated and monitored in real time.

In some embodiments, price discount data is represented in a tiered structure. Using a tiered structure a price is subject to multiple discounts over a various different time periods, eventually settling at a final discounted price. For example, a product may be discounted 20% a week before the product's expiration date. For any remaining units of the product not sold by four (4) days before the expiration date, the discount may be increased to 50%. Additional discounts may be generated as the expiration date draws closer. Additionally, or alternatively, the discounts may include a buy-one-get-one free offer, or any other similar incentive to purchase an item.

Price discount data can be maintained for items (e.g., clothing items) on a per size basis. When a particular size of items is selling at a slower rate than other sizes for the same item (e.g., identified by SKU), a discount or other incentive (e.g., 30% off, two for one, etc) for the particular size of item can be formulated and issued to consumers.

In some embodiments, product life cycle data and price discount data are contained in a single database. Each product is listed and a date given on which the price is to be discounted if the item has not already sold. Alternately, product life cycle data and price discount data are stored separately, but are periodically compared and compiled so as to create a record of when each product or class of products is to be discounted.

Contact database 109 contains contact data related to entities (e.g., individuals and/or businesses) that are to be notified electronically means when a price discount is imminent or has already occurred (“consumer contact data”). Consumer contact data can include a listing of cell phone numbers enabled to receive SMS text messages whereby communication can be made with an individual or business interested in receiving price discount information. Other alternative consumer contact data can include, but is not limited to, cell phone numbers enabled to receive picture messages, e-mail addresses, home, business or cell phone numbers, social networking (e.g., Facebook, MySpace) account information, and the like. Consumer contact data can include personal information, including contact information, of all entities registered to receive price discount notifications.

Entities can opt-in to receive specific price discount notifications. Opting-in can include a consumer deciding which products or classes or groups of products he or she would like to receive notifications about, which stores, locations, territories or regions the consumer would like to receive information from, how often the consumer desires to receive price discount notifications and other like information. For example, a consumer in opting-in might elect to receive all price discount notifications from a single location of a store concerning all products. Another consumer might elect to receive all price discount notifications from any store or business his or her particular region concerning a particular product of class or group of products.

Opting-in can include submitting information via the Internet, World Wide Web, or e-mail. Opting-in can take place on a webpage or website of an individual business, or alternatively may take place on the webpage or website of a central service that disperses consumer contact information to other stores, businesses and companies that practice this invention. Alternatively, a consumer can opt-in by using a mobile application (e.g., a mobile app for the iPhone or cell phone capable of running applications) to submit his or her consumer contact information. The mobile application can also be used to receive price discount notifications.

In other embodiments, the consumer contact data comprises any available contact information of individuals or businesses, regardless of whether the individual or business had previously registered, signed-up or expressed interest in receiving price discount notifications. This consumer contact data could be gathered through the phone book, Internet or World Wide Web, or by purchasing advertising data.

Product life cycle data, price discount data, and consumer contact data can be integrated into a single database. This single database can thus include a listing of products or classes of products, the times and/or dates their prices are to be discounted, and consumer contact information for one or more persons or businesses to receive a price discount notification.

Further, different arrangements of product life cycle data, price discount data, and consumer contact data can be stored individually, or combined in one or more databases. For example, product life cycle data and the price discount data can be stored in a single database and the consumer contact data can be stored in a separate database. Alternatively, product life cycle data can be stored in one database, and the price discount data and consumer contact data can be stored together in a second database. Furthermore, and as depicted in computer architecture 100, each type of data can be separated and stored in one or more databases, or combined and stored in one or more databases.

As depicted, discount system 101 is connected to communication module 111. Communication module 111 is configured to transmit price discount notifications, in some embodiments essentially in real time. Communication module 111 can receive a discount record and send corresponding discount notifications directly to any relevant entities (e.g., to consumer side electronics 104 for subsequent viewing by consumer 106). Alternately or in combination, discount notifications can be sent to electronic pointing locations (e.g., electronic positing location 103), such as for example, a company's blog, social network site, website, through a micro-blogging service such as Twitter, and the like. Thus, any entity (individual or business) that accessing the posting location, for example, the practicing entity's blog, social network site, website, or micro-blog is able to become aware of the price discount notification.

In some embodiments, price discount notifications (e.g., discount notification 144) are transmitted by SMS text messages directly to consumers. Alternatively or in combination, price discount notifications can be transmitted by picture messages, e-mail, voice messages, or by posting messages or comments on an individual's or business's social network site, website, blog, or micro-blog, and the like. Further, in some embodiments, price discounts are communicated on a multi-channel communication basis. For example, price discounts can be communicated on any combination of one or more of: voice interactive voice response (“IVR”), point of sale, mobile, telephonic, interactive, Internet, cable, and broadcast media.

Upon receiving a discount notification, one or more entities may choose to purchase a product at a discounted price (e.g., purchase 116). The owner, manager, or other user of discount system 101 use purchase data as feedback for making subsequent discounting decisions. For example, data on the purchases of discounted items, including who purchased the item, when it was purchased, and/or the means through which the purchaser was made aware of the discounted item can be gathered. The purchase data can be utilized to optimize price discount data used to set subsequent discounts. Price discount data can be used to optimize revenue for subsequent discounts.

For example, it may be possible that prices were discounted too soon and/or by too much and more profit could have been made by transmitting a price discount notification at a later time and/or date. Alternatively, it may be that prices were discounted too late and/or by not enough and the discounted items were not sold before their expiration. The updated database of when to discount prices is then used for the subsequent instance of price discounts.

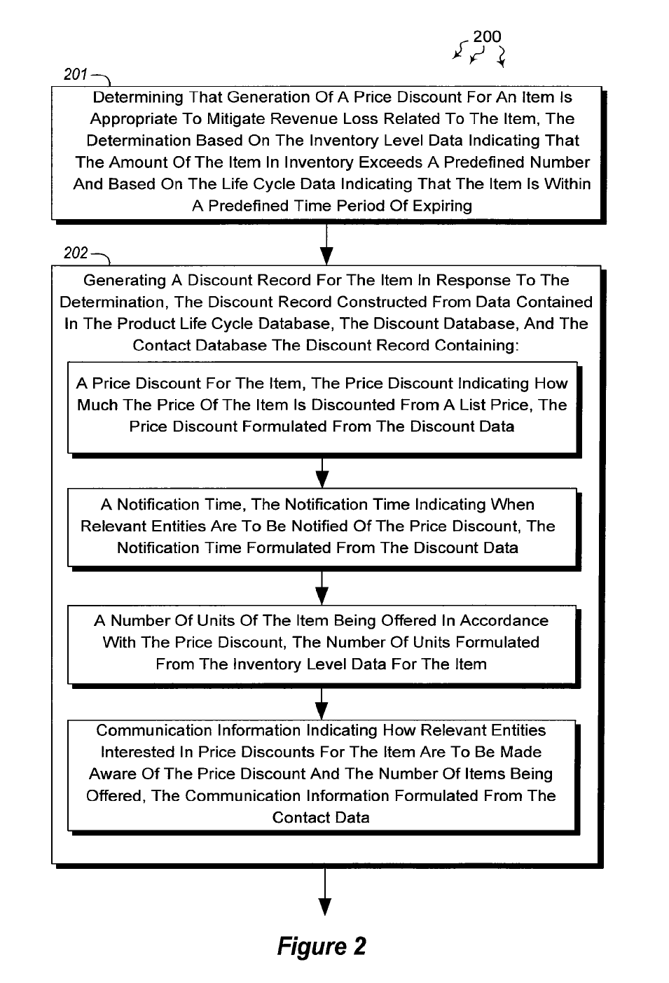

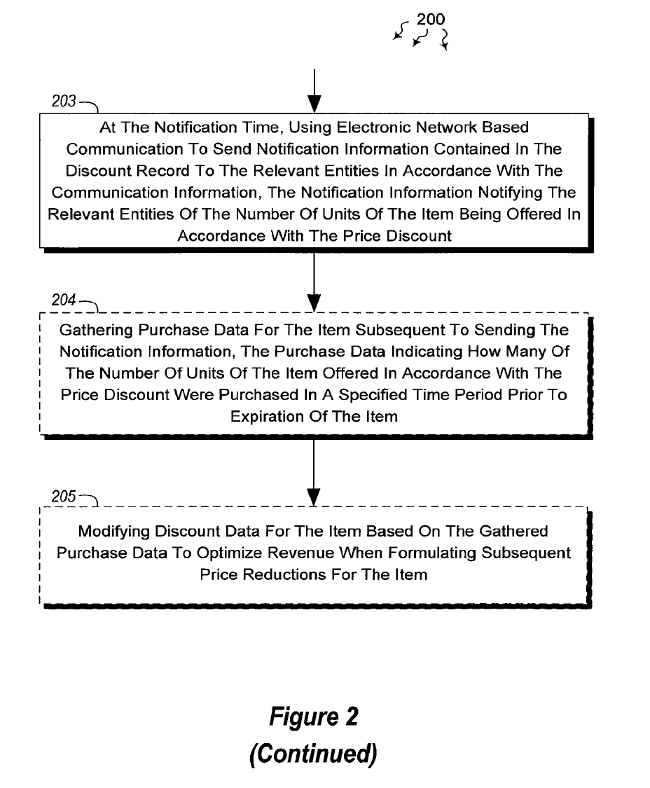

FIG. 2 illustrates a flow chart of an example method 200 for communicating price discounts, with optional feedback for optimizing subsequent revenue. Method 200 will be described with respect to the components and data depicted in computer architecture 100.

Method 200 includes an act of determining that generation of a price discount for an item is appropriate to mitigate revenue loss related to the item, the determination based on the inventory level data indicating that the amount of the item in inventory exceeds a predefined number and based on the life cycle data indicating that the item is within a predefined time period of expiring (act 201). For example, life cycle monitoring module 131 can monitor life cycle data 124. Life cycle monitoring module 131 can determine that a price discount for a product is appropriate to mitigate revenue loss for an item. Life cycle monitoring module 131 can based the determination on the inventory level for the item and when the item is to expire.

Thus, the need for and/or magnitude of a price discount can be formulated based on an inventory level for an item and immediacy of expiration of the item. When an inventory level is higher and/or expiration of an item is closer, the need for and/or magnitude of a price discount can be greater. For example, when a particular size of a shirt is selling at a slower sale rate relative to other sizes of the shirt, the need for and/or magnitude of a discount for the particular size of the shirt can be greater in order to maintain similar sale rates for all sizes of the shirt. On the other hand, when an inventory level is lower and/or expiration of an item is further away, the need for and/or magnitude of a price discount can be less.

When, life cycle monitoring module 131 determines a price discount for a product is appropriate, life cycle monitoring module 131 sends product ID 143 to discount record generation module 132. Product ID 143 identifies the product for which a discount is to be generated.

Method 200 includes an act of generating a discount record for the item in response to the determination, the discount record constructed from data contained in the product life cycle database, the discount database, and the contact database (act 202). For example, in response to receiving product ID 143, discount record generation module 132 can generate discount record 113 for the identified product. Discount record generation module 132 can be constructed from inventory data 141, discount data 122, and contact data 123.

Discount record 113 can contain a price discount for the identified item. The price discount indicates how much (e.g., amount or percentage) the price of the identified item is discounted from a list price. The price discount is formulated from discount data 122. Discount record 113 can contain a notification time. The notification time indicates when relevant entities are to be notified (e.g., consumer 106 and/or electronic posting location 103) of the price discount for the identified item. The notification time is also formulated from discount data 122.

Discount record 113 can contain the number of units of the identified item being offered in accordance with the price discount. The number of units can be formulated from inventory data 141 (i.e., the inventory level data for the identified item). Discount record 113 can contain communication information indicating how relevant entities (e.g., consumer 106 and/or electronic posting location 103) interested in price discounts for the identified item are to be made aware of the price discount and the number of items being offered. Communication information can be formulated from contact data 123.

Subsequently, discount record generation module 132 can send discount record 113 to communication module 111. Communication module 111 can receive discount record 113 from discount record generation module 132

Method 200 includes an act of, at the notification time, using electronic network based communication to send notification information contained in the discount record to the relevant entities in accordance with the communication information, the notification information notifying the relevant entities of the number of units of the item being offered in accordance with the price discount (act 203). For example, at the notification time, communication module 111 can send discount notification 142 to relevant entities, such as, for example, consumer side electronics 104 and/or electronic posting location 103, in accordance with the communication information contained in discounts record 113. Discount notification 142 can indicate how many units of the identified product (identified by product ID 143) are being offered in accordance with the price discount.

In some embodiments, a consumer electronic device (e.g., a PDA or mobile phone) is notified (e.g., via an SMS message) of a price discount. As such, the user of the device is more immediately notified of the price discount. For example, when discount notification 142 is sent to consumer side electronics 104, consumer 106 is provided more immediate access to discount notification 142. When discount notification 142 is sent electronic posting location 103, consumer 106 may have to perform various operations (e.g., logging in) to access discount notification 142 from electronic posting location 103.

After receiving discount notification 142, consumer 106 can initiate purchase 116 to purchase the identified item and take advantage of the price discount. One or more other entities may also purchase the identified item and take advantage of the price discount. Collectively the information can be represented in sales data 117.

Accordingly, method 200 optionally includes an act of gathering purchase data for the item subsequent to sending the notification information, the purchase data indicating how many of the number of units of the item offered in accordance with the price discount were purchased in a specified time period prior to expiration of the item (act 204). For example, discount system 101 can gather sales data 117 for the identified item. Sales data 117 can indicate how many units of the indentified item were purchased in accordance with the price discount in discount record 113 prior to expiration of the identified item (or prior to discount terms changing in accordance with tiered discounting).

Method 200 also optionally includes an act of modifying discount data for the item based on the gathered purchase data to optimize revenue when formulating subsequent price reductions for the item (act 205). For example, discount system 101 can modify discount data 122 based on sales data 117 to optimize revenue when formulating subsequent price reductions for the identified item. For example, if units of the identified item sold out to fast, the magnitude of the discount can be reduced or the notification time moved closer to the time of expiration. On the other hand, if too many units of the identified item spoiled, the magnitude of the discount can be increased or notification time moved further from the time of expiration. Accordingly, based on purchasing feedback, discount data can be optimized to increase revenue from subsequent price discounts for the identified item. For example, the magnitude and/or timing of a price discount can be balanced to maximize revenue based on revenue performance of prior price discounts.

Some embodiments of the invention relate more specifically to sales of grocery and retail products. For example, consumers can be alerted to an imminent or impending price reduction on grocery or retail items due to the grocery or retail items perishing or otherwise expiring at some point in the future. The use of electronic messages (e.g., SMS messages) permits potential consumers to become aware of price reductions in a more expedited manner. That is, price discounts can be transmitted closer to real time. Alternately and/or in combination, price discount notifications can be transmitted, after the occurrence of a predetermined condition, using picture messages, e-mail, voice messages, or by posting messages or comments on an individual's or business's social network site. For example, a communications module may call a home, business or cell phone number. If someone answers the phone, an oral price discount notification can be transmitted over the phone to the consumer. On the other hand, if the call is picked up by an answering machine or voicemail service, the price discount notification is left as a message or voicemail. In one embodiment, a price discount notification includes a pre-recorded voice message. In alternative embodiments, a price discount notification is generated via any text-to-speech system or similar technology.

Additionally, the present invention can be used in conjunction with inventory management systems that monitor inventory levels of various types of weapons and use by dates for such weapons, including munitions. In such a system, a notification as described hereon can be generated when weapons are approaching a use by date. Such a notification can be sent to various management personnel, such as military officers, to inform them that specific weapons must be used by an impending date.

Accordingly, embodiments include alerting customers (e.g., to an imminent or impending) price reduction on (e.g., perishable) items. More particularly, embodiments include compiling product and consumer data to determine which consumers are to receive notifications of impending price discounts. This compilation of data is transmitted to a communications system, which then transmits via instantaneous electronic means, such as SMS text message, picture message, e-mail, or micro-blogging, a price discount notification. Computer systems enabled to practice the present invention, comprising one or more databases and a communications system configured to transmit price discount notifications, are also described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for managing the distribution of notifications to a plurality of subscribers, the method comprising:
a computing system generating an electronic record to be used for distributing at least one notification to one or more subscribers, the computing system comprising at least one processor and system memory, the electronic record comprising:
notification data to be included in the at least one notification;
one or more electronic posting location where the at least one notification is to be sent; and
first timing data specifying timing for sending the at least one notification to the one or more subscribers at a predetermined time prior to a particular event;
the computing system detecting one or more predetermined condition;
the computing system, in response to detecting the one or more predetermined condition, generating the one or more notification;
the computing system sending the at least one notification to one or more electronic posting locations corresponding to each of the one or more subscribers in accordance with the first timing data, such that the at least one notification is sent to the one or more subscribers at the predetermined time prior to the particular event;
the computing system receiving new notification data, the new notification data being received subsequent to and at least partially responsive to the at least one notification having been sent to the one or more subscribers; and
the computing system, responsive to the new notification data, generating a new electronic record to be used for distributing at least one new notification, the new electronic record having second timing data that is different than the first timing data.

2. The method of claim 1, wherein the one or more electronic posting location requires the one or more corresponding subscribers to login into the one or more electronic posting location prior to providing access to the at least one notification at the one or more electronic posting location.

3. The method of claim 1, wherein the at least one notification includes a first notification and a second notification that are sent to a corresponding first subscriber and second subscriber, respectively, and wherein first notification data included in the first notification is different than second notification data included in the second notification based in response to the first subscriber having a different subscription level than the second subscriber.

4. The method of claim 1, wherein the notification data included in the at least one notification specifies timing for the subscriber to take a predetermined action.

5. A computing system comprising:
at least one processor; and
one or more storage device having stored instructions which, when executed by the at least one processor, implement a method for managing the distribution of notifications to a plurality of subscribers, the method comprising:
a computing system generating an electronic record to be used for distributing at least one notification to one or more subscribers, the computing system comprising at least one processor and system memory, the electronic record comprising:
notification data to be included in the at least one notification;
one or more electronic posting location where the at least one notification is to be sent; and
first timing data specifying timing for sending the at least one notification to the one or more subscribers at a predetermined time prior to a particular event;
the computing system detecting one or more predetermined condition;
the computing system, in response to detecting the one or more predetermined condition, generating the one or more notification;
the computing system sending the at least one notification to one or more electronic posting locations corresponding to each of the one or more subscribers in accordance with the first timing data, such that the at least one notification is sent to the one or more subscribers at the predetermined time prior to the particular event;
the computing system receiving new notification data, the new notification data being received subsequent to and at least partially responsive to the at least one notification having been sent to the one or more subscribers; and
the computing system, responsive to the new notification data, generating a new electronic record to be used for distributing at least one new notification, the new electronic record having second timing data that is different than the first timing data.

6. The computing system of claim 5, wherein the one or more electronic posting location requires the one or more corresponding subscribers to login into the one or more electronic posting location prior to providing access to the at least one notification at the one or more electronic posting location.

7. The computing system of claim 5, wherein the at least one notification includes a first notification and a second notification that are sent to a corresponding first subscriber and second subscriber, respectively, and wherein first notification data included in the first notification is different than second notification data included in the second notification based in response to the first subscriber having a different subscription level than the second subscriber.

8. The computing system of claim 5, wherein the notification data included in the at least one notification specifies timing for the subscriber to take a predetermined action.
